(19) United States
(12) Patent Application Publication
(10) Pub. No.: US 2025/0070522 A1
(43) Pub. Date: Feb. 27, 2025

(54) ADAPTER COMPATIBLE WITH MANY TYPES OF PLUG PINS

(71) Applicant: Dongguan Wontravel Electric Co.,Ltd, Dongguan (CN)

(72) Inventors: Liangguan LIN, Dongguan (CN); Xiaolong LI, Dongguan (CN); Lei HU, Dongguan (CN); Cai HUANG, Dongguan (CN)

(21) Appl. No.: 18/939,863

(22) Filed: Nov. 7, 2024

(30) Foreign Application Priority Data
Aug. 15, 2024 (CN) 202421972220.6

(51) Int. Cl. H01R 31/06

(52) U.S. Cl. CPC H01R 31/06

(57) ABSTRACT

An adapter compatible with multiple types of plug pins includes a casing assembly, a bracket, a first conductive metal component, a second conductive metal component and a locking mechanism. A cavity is provided within the casing assembly. The bracket is detachably provided within the cavity. The first conductive metal component is provided on the bracket. The second conductive metal component is fixedly provided on the bracket. The locking mechanism is movably provided on the bracket, and includes a limiting part and an unlocking part. An outer side surface of the casing assembly is provided with a slot for slidable connection with a plug module.

### CROSS-REFERENCE TO RELATED APPLICATIONS

This application claims the benefit of priority from Chinese Patent Application No. 202421972220.6, filed on Aug. 15, 2024. The content of the aforementioned application, including any intervening amendments made thereto, is incorporated herein by reference in its entirety.

### TECHNICAL FIELD

This application relates to adapters, and more particularly to an adapter compatible with many types of plug pins.

### BACKGROUND

Overseas travel or business trip has become increasingly popularized. Many types of electrical plugs have been designed to respectively adapt to different power outlets in different countries. Generally, the domestic electrical devices cannot be compatible with foreign sockets, causing significant inconvenience.

Therefore, to make the travel more convenient, an adapter that can convert plugs of different specifications to fit the foreign sockets has emerged on the market. Current adapters are designed with interchangeable plugs of various specifications, allowing users to switch plugs to match the local sockets, making it easier to charge their personal devices.

However, the current adapters on the market have several deficiencies. During the assembly, the connection between the plug and the adapter body is often unstable, which will make the plug loosened, especially after multiple switches. Moreover, the installation gap will further affect the connection between the plug and the adapter body. Additionally, the improper internal conductive metal structure will exacerbate the unstable connection between the plug and the adapter body, thereby affecting the electrical conduction.

Therefore, there is an urgent need to design and develop an adapter compatible with multiple types of plug pins to address at least one of the aforementioned technical issues.

### SUMMARY

An object of the disclosure is to provide an adapter with multiple types of interchangeable plug pins to overcome the defects in the prior art.

Technical solutions of the present disclosure are described as follows.

An adapter with multiple types of interchangeable plug pins, comprising:
a casing assembly;
a bracket;
a first conductive metal component;
a second conductive metal component; and
a locking mechanism;
wherein a cavity is provided within the casing assembly, and a slot is provided on an outer surface of the casing assembly;
the bracket is detachably provided within the cavity;
the first conductive metal component is provided on the bracket, and provided with an elastic connection portion for plug-in connection;
the second conductive metal component is fixedly provided on the bracket; a first end of the second conductive metal component is electrically connected to the first conductive metal component, and a second end of the second conductive metal component is configured to extend along an outer wall of the casing assembly into the slot; and the second end of the second conductive metal component is configured to extend toward an opening of the slot; and
the locking mechanism is movably provided on the bracket, and comprises a limiting part and an unlocking part; the limiting part is provided with an elastic support, and is configured to extend partially into the slot under the action of an elastic force; and the unlocking part is structurally matched with the limiting part, and is configured to push the limiting part out to overcome the elastic force to exit the slot.

In some embodiments, the bracket is provided with a first plate which is vertically arranged, an assembly frame is provided along the first plate to clamp the first conductive metal component, and the second conductive metal component is fixedly provided on the assembly frame.

In some embodiments, the number of the first conductive metal component is two, and two first conductive metal components are respectively corresponding to a live wire and a neutral wire; each of the two first conductive metal components comprises a second plate; the second plate is provide with a plurality of elastic arms; a space between the plurality of elastic arms and the second plate is configured as the elastic connection portion; and each of the two first conductive metal components is provided with a first connecting arm electrically connected to the second conductive metal component.

In some embodiments, the number of the second conductive metal component is two, and two second conductive metal components are respectively corresponding to the two first conductive metal components; each of the two second conductive metal components comprises a main body; a first end of the main body is electrically connected to a corresponding one of the two first conductive metal components, and a second end of the main body is configured to extend along the main body into the slot; the second end of the main body is provided with a second connecting arm extending toward the opening of the slot; and a clamping space is defined between the second connecting arm and a side wall of the slot.

In some embodiments, the main body is further provided with a reinforcing arm opposite to the second connecting arm, and the clamping space is defined between the reinforcing arm and the second connecting arm.

In some embodiments, a sliding groove is provided on the first plate, the limiting part is provided on an upper side or a lower side of the sliding groove, and the limiting part comprises:
a cross beam;
a connecting leg;
a limiting block; and
a pushing block;
wherein the elastic support is provided between the cross beam and the first plate;
the connecting leg is provided on one side of the cross beam, the first plate is provided with a hole, and the connecting leg is configured to pass through the hole and be slidingly connected with the hole along an axis of the connecting leg for limited movement;
the limiting block is provided on the cross beam, and configured to extend into the slot along a side wall of the casing assembly; and
the pushing block is provided on the cross beam, and configured to extend toward the sliding groove; and
the unlocking part comprises:
a second plate;
an elastic part; and
an abutting block;
wherein the second plate is slidably connected within the sliding groove;
the elastic part is provided within the sliding groove, and is configured to provide an elastic force toward an outer side of the sliding groove to the second plate; and
the abutting block is provided on the second plate, and is corresponding to the pushing block; the abutting block is configured to extend toward the limiting part; and
opposite sides of the pushing block and the abutting block are each configured as a slope.

In some embodiments, the adapter further comprises a sliding limit mechanism; the sliding limit mechanism comprises a guide rail and a guiding groove; the guide rail is arranged at the sliding groove or the second plate; the guiding groove is arranged at the sliding groove or the second plate; and an end of the second plate away from the elastic part is configured as a pressing end to be pressed to overcome the elastic force of the elastic part to slide.

In some embodiments, the casing assembly is provided with a jack corresponding to the elastic connection portion, and the jack is a two-pole jack or a three-pole jack.

In some embodiments, a circuit board is provided within the cavity, and is electrically connected to the first conductive metal component; and a plurality of electronic ports are provided on the circuit board for current transmission.

In some embodiments, the casing assembly comprises:
a bottom casing;
a middle casing; and
a top cover;
wherein the cavity is provided in the bottom casing;
the middle casing is configured to enclose the cavity, and a plurality of connection holes are provided on the middle casing for bolted connection to the bottom casing; and
the top cover is in snap-fit connection with the middle casing.

The present disclosure has the following beneficial effects.

During the use of the adapter proposed herein, the plug module is inserted into the slot through the opening, such that the second conductive metal component is engaged with the plug-in hole to establish an electrical connection with the plug pins on the plug module. The plug module is locked within the slot through the cooperation between the limiting hole and the limiting part. By replacing the plug module with different pin specifications, the adapter can adapt to sockets from different regions, meeting the charging needs for appliances. The technical solutions provided by the present disclosure ensure that during the process of slidably inserting the plug module into the slot, the second conductive metal component extending toward the slot opening is gradually plugged into the plug-in hole, achieving an electrical connection with the plug pins. Meanwhile, as the plug module slides into the slot, the limiting member gradually engages with the limiting hole, thereby locking the plug module securely within the slot. Through the above technical solutions, the assembly accuracy of the adapter will not be reduced even after multiple insertions of the plug module, preventing the occurrence of increased assembly gaps. Moreover, the slidable connection of the plug module into the slot along the opening makes the assembly process relatively smooth, avoiding intense movements and excessive pushing forces. This reduces impact and damage to the plug module, ensuring the assembly precision reliable connection between the plug module and the casing assembly, and preventing the plug module from loosening.

### BRIEF DESCRIPTION OF THE DRAWINGS

FIG. 1 schematically shows an assembly between an adapter in accordance with an embodiment of the present disclosure and a plug module;

FIG. 2 is an exploded view of the adapter in accordance with an embodiment of the present disclosure and the plug module;

FIG. 3 is a structural schematic diagram of the adapter in accordance with an embodiment of the present disclosure;

FIG. 4 is an exploded view of the adapter in accordance with an embodiment of the present disclosure;

FIG. 5 is a structural schematic diagram of a bracket, a first conductive metal component, a second conductive metal component, and a locking mechanism in accordance with an embodiment of the present disclosure;

FIG. 6 is an exploded view 1 of the bracket, the first conductive metal component, the second conductive metal component, and the locking mechanism in accordance with an embodiment of the present disclosure;

FIG. 7 is an exploded view 2 of the bracket, the first conductive metal component, the second conductive metal component, and the locking mechanism in accordance with an embodiment of the present disclosure;

FIG. 8 is a structural schematic diagram of the plug module in accordance with an embodiment of the present disclosure;

FIG. 9 is an exploded view of the plug module in accordance with an embodiment of the present disclosure;

FIG. 10 is a structural schematic diagram of the second conductive metal component in accordance with an embodiment of the present disclosure;

FIG. 11 is a structural schematic diagram of the first conductive metal component corresponding to a ground wire in accordance with an embodiment of the present disclosure; and

FIG. 12 is a structural schematic diagram of the two first conductive metal components respectively corresponding to a live wire and a neutral wire in accordance with an embodiment of the present disclosure.

In the figures: 100—casing assembly; 221—second plate; 411—mounting cavity; 101—cavity; 222—elastic arm; 412—first sliding groove; 102—two-pole jack; 223—first connecting arm; 112—sliding block; 103—three-pole jack; 211—main body; 413—conductive sheet; 110—slot; 212—connecting terminal; 414—plug-in terminal; 111—opening; 213—second connecting arm; 500—circuit board; 214—clamping space; 501—electronic port; 201—connection portion; 215—reinforcing arm; 106—bottom casing; 210—second conductive metal component; 205—second sliding groove; 104—middle casing; 300—locking mechanism; 311—cross beam; 105—top cover; 310—limiting part; 312—connecting leg; 325—pressing end; 320—unlocking part; 313—limiting block; 400—plug module; 314—pushing block; 401—plug pin; 321—third plate; 402—plug-in hole; 322—elastic part; 403—limiting hole; 323—abutting block; 202—bracket; 324—slope; 203—first plate; 206—guide rail; 204—assembly frame; 220—first conductive metal component; 410—seat; and 200—conductive module.

### DETAILED DESCRIPTION OF EMBODIMENTS

In order to facilitate the understanding of technical solutions of the present disclosure, the present disclosure will be further described in conjunction with the embodiments and the accompanying drawings. It should be noted that the embodiments are merely exemplary, and are not intended to limit the present disclosure. A detailed description of the present disclosure will be provided below in conjunction with the accompanying drawings.

The embodiment of the present disclosure provides an adapter compatible with multiple type of plug pins. By providing multiple plug modules 400 with different specifications of plug pins 401, users can select the desired plug module 400 for use, thereby facilitating charging their electronic devices while traveling overseas.

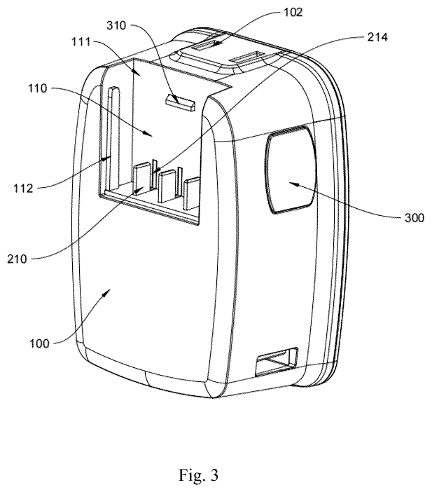

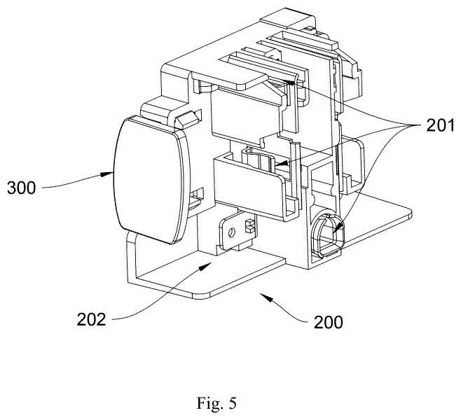

As shown in FIGS. 3-7, an embodiment of the present disclosure provides an adapter, including a casing assembly 100, a bracket 202, a first conductive metal component 220, a second conductive metal component 210 and a locking mechanism 300. A cavity 101 is provided within the casing assembly 100, and a slot 110 is provided on an outer surface of the casing assembly 100. The bracket 202 is detachably provided within the cavity 101. The first conductive metal component 220 is provided on the bracket 202, and provided with an elastic connection portion 201 for plug-in connection. The second conductive metal component 210 is fixedly provided on the bracket 202, a first end of the second conductive metal component 210 is electrically connected to the first conductive metal component 220, and a second end of the second conductive metal component 210 is configured to extend along an outer wall of the casing assembly 100 into the slot 110, and the second end of the second conductive metal component 210 is configured to extend toward an opening 111 of the slot 110. And the locking mechanism 300 is movably provided on the bracket 202, and includes a limiting part 310 and an unlocking part 320. The limiting part 310 is provided with an elastic support, and is configured to extend partially into the slot 110 under the action of an elastic force. And the unlocking part 320 is structurally matched with the limiting part 310, and is configured to push the limiting part 310 out to overcome the elastic force to exit the slot 110.

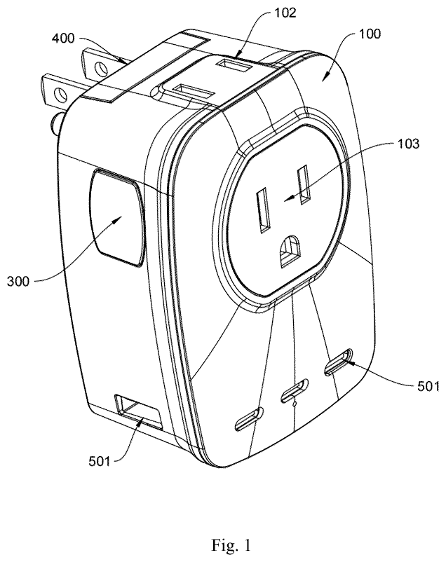

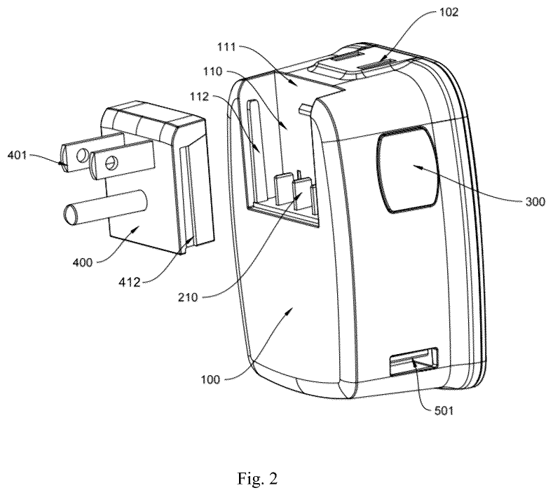

It can be envisioned that, as shown in FIGS. 1-2, in an embodiment, a two-pole jack 102 and a three-pole jack 103 are provided on the casing assembly 100. Correspondingly, two elastic connection portions 201 are provided on the first conductive metal component 220, and each of elastic connection portion 201 is configured to match the two-pole jack 102 and the three-pole jack 103, thereby accommodating both two-pole and three-pole sockets. Similarly, in some embodiments, the number of the connection portion 201 is two that are adapted to two-pole sockets, in which case two connection portions 201 are provided on the casing assembly 100.

In an embodiment, the first conductive metal component 220, the second conductive metal component 210 and the locking mechanism 300 are provided on the bracket 202, resulting in a compact overall structure. The first conductive metal component 220 and the second conductive metal component 210 are tightly connected to ensure the socket has a compact overall structure.

During use, plug module 400 with different specifications of plug pins can be snap-fitted into slot 110, allowing for the replacement of plug modules 400 with different specifications according to the electrical requirements of different regions. Specifically, the plug module 400 is configured to inserted into the slot 110 along the opening 111 of the slot 110, at which point the plug module 400 is connected with the second end of the second conductive metal component 210 within the slot 110, thereby establishing an electrical connection. Meanwhile, the plug module 400 is snap-fitted by the limiting part 310 to prevent the plug module 400 from falling out within the slot 110. The technical solutions provided herein enables the adapter to support interchangeable plug modules 400 according to different regional electrical standards, ensuring proper use of the socket for charging personal electronic devices.

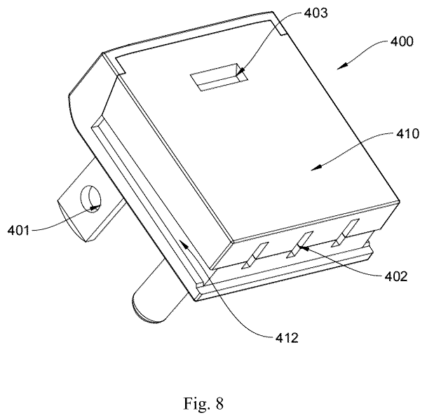

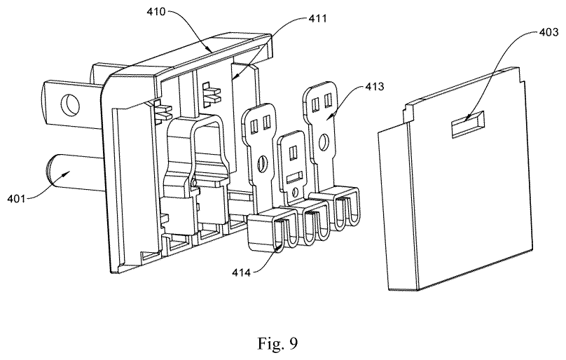

In an embodiment, FIGS. 8-9 are a structural schematic diagram of the plug module 400. The plug module 400 includes a seat 410 and a conductive sheet 413. A mounting cavity 411 is provided within the seat 410, and the plug pins 401 are fixedly provided on the seat 410. A first sliding groove 412 is provided on the sidewall of the seat 410, and a sliding block 112 is provided within the slot 110, and the sliding block 112 and the first sliding groove 412 is configured as a sliding pair. The conductive sheet 413 is fixedly provided within the mounting cavity 411, and includes at least two that are compatible with the second conductive metal component 210. A first end of the conductive sheet 413 is connected to the plug pin 401, and a second end of the conductive sheet 413 is provided with an elastic plug-in terminal 414, which corresponds to a plug-in hole 402.

When the plug module 400 is slidably connected within the slot 110, it can slide along the first sliding groove 412 and the sliding block 112, thereby defining the sliding direction and movement precision of the plug module 400. Additionally, the elastic plug-in terminal 414 on the conductive sheet 413 is configured to interconnect with the second conductive metal component 210, to elastically clamp the second conductive metal component 210. This ensures a tight connection between the conductive sheet 413 and the second conductive metal component 210, preventing the instable current transmission between components and avoiding potential safety hazards.

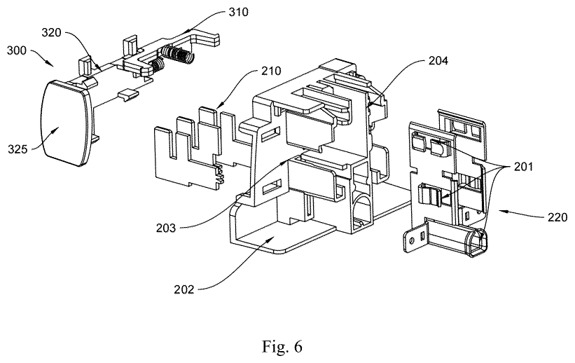

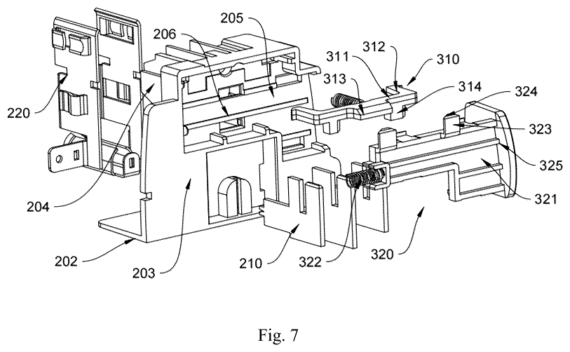

In an embodiment, the second conductive metal component 210 and the first conductive metal component 220 are configured as an electrical connection module to connect with the plug module 400, and together serve as the socket for electrical appliance plug-ins. As shown in FIGS. 3-7, the bracket 202 is provided with a first plate 203 which is vertically arranged. An assembly frame 204 is provided along the first plate 203 to clamp the first conductive metal component 220. The second conductive metal component 210 is fixedly provided on the assembly frame 204. The number of the first conductive metal component 220 is two, and two first conductive metal components 220 are respectively corresponding to a live wire and a neutral wire. Each of the two first conductive metal components 220 includes a second plate 221, which has an elongated plate-like structure. The second plate 221 is provided with a plurality of elastic arms 222. A space between the plurality of elastic arms 222 and the second plate 221 is configured as the elastic connection portion 201. Each of the first conductive metal components 220 is provided with a first connecting arm 223 electrically connected to the second conductive metal component 210. In an embodiment, the number of the first conductive metal component 220 is three, and three first conductive metal components 220 are respectively corresponding to the live wire, the neutral wire and an earth wire. It can be envisioned that, the number of the first conductive metal component 220 can be two, and two first conductive metal components 220 are respectively corresponding to the live wire and the neutral wire. In an embodiment, the bracket 202 is provided with the first plate 203, allowing the first conductive metal component 220 to be vertically provided on the assembly frame 204, which increases the contact area between the first conductive metal component 220 and the first plate 203. Additionally, as shown in FIGS. 6-7, a plurality of snap-fit positions are provided on the assembly frame 204. After the first conductive metal component 220 is vertically provided on the assembly frame 204, the plurality of snap-fit positions engage with the first conductive metal component 220 to ensure the stability of its installation.

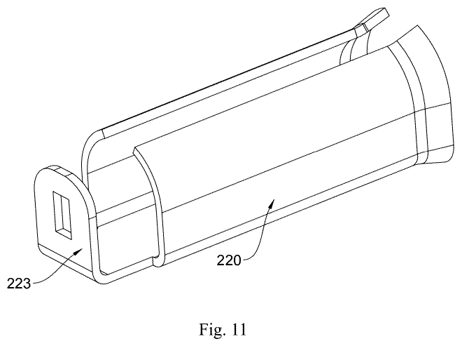

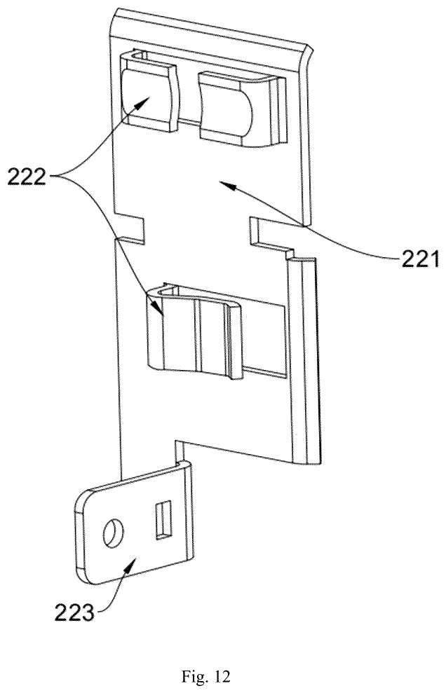

Referring to an embodiment shown in FIGS. 11-12, two first conductive metal components 220 are respectively corresponding to the live wire and the neutral wire. Each of the two first conductive metal components 220 includes the second plate 221, which has the elongated plate-like structure. The second plate 221 is provided with the plurality of elastic arms 222. The space between the plurality of elastic arms 222 and the second plate 221 is configured as the elastic connection portion 201. Each of the first conductive metal components 220 is provided with the first connecting arm 223 electrically connected to the second conductive metal component 210. The first conductive metal component 220 connected to the earth wire has a cylindrical body for plug insertion, the first connecting arm 223 is provided at the rear of the first conductive metal component 220, and is connected to the second conductive metal component 210.

By means of the second plate 221, the current-carrying capacity of the first conductive metal component 220 is enhanced, resulting in more stable current transmission. Additionally, elastic arms 222 are provided on the second plate 221 to clamp the inserted plug securely, ensuring a stable connection with the plug.

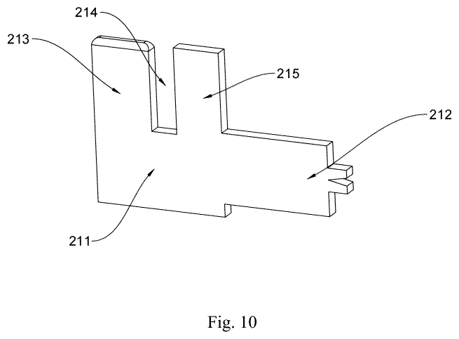

In an embodiment, as shown in FIGS. 10 and 12, the second conductive metal component 210 includes a main body 211. A first end of the main body 211 is provided with a connecting terminal 212, which is electrically connected to the first conductive metal component 220. And a second end of the main body 211 is configured to extend along the main body 211 into the slot 110. And the second end of the main body 211 is provided with a second connecting arm 213 extending toward the opening 111 of the slot 110. And a clamping space is defined between the second connecting arm 213 and a sidewall of the slot 110.

An elastic leg is provided on the connecting terminal 212. Correspondingly, a hole is provided on the first connecting arm 223 of the first conductive metal component 220, matching the elastic leg. This allows the elastic leg to be inserted into the hole and locked in place the action of the elastic force, ensuring a tight connection between the second conductive metal component 210 and the first conductive metal component 220. Additionally, the second connecting arm 213 is configured to extend toward the opening 111 of the slot 110, When the plug module 400 is slidably connected within the slot 110 along the opening 111, it interconnects with the plug-in holes 402 and establishes an electrical connection with the plug pins 401. Additionally, there is the clamping space 214 between the second connecting arm 213 and the side wall of the slot 110, after the plug module 400 is slidably connected within the slot 110, the rear side portion of the plug module 400 is provided within the clamping space 214, thereby securely clamping the plug module 400 in place and ensuring its stability within the slot 110.

In an embodiment, the main body 211 is further provided with a reinforcing arm 215 opposite to the second connecting arm 213. The clamping space is defined between the reinforcing arm 215 and the second connecting arm 213. During assembly, the reinforcing arm 215 is provided inside the bracket 202, thereby increasing the contact area between the second conductive metal component 210 and the bracket 202, ensuring the secure attachment of the second conductive metal component 210 to the bracket 202.

In order to lock the plug module 400 after it is inserted into the slot 110 and prevent it from falling out, in an embodiment, a second sliding groove 205 is provided on the first plate 203. And the limiting part 310 is provided on an upper side or a lower side of the second sliding groove 205. The limiting part 310 includes a cross beam 311, a connecting leg 312, a limiting block 313, and a pushing block 314. The elastic support is provided between the cross beam 311 and the first plate 203. The connecting leg 312 is provided on one side of the cross beam 311, a hole is provided on the first plate 203, and the connecting leg 312 is configured to pass through the hole and be slidingly connected with the hole along an axis of the connecting leg for limited movement. The limiting block 313 is provided on the cross beam 311, corresponding to the limiting hole 403, and the limiting block 313 is provided on the cross beam 311 and configured to extend toward the second sliding groove 205. In other words, the limiting block 313 is configured to extend into the slot 110 under the action of the elastic support, allowing it to snap-fit the limiting hole 403 of the plug module 400, thereby securing the plug module 400 within the slot 110. It can be envisioned that, in response to a case in which the plug module 400 is slid along the opening 111 and entered the slot 110, the side wall of the seat 410 of the plug module 400 is configured to come into contact with the limiting block 313, causing the cross beam 311 to overcome the elastic support to move away from the slot 110. This action results in the limiting block 313 being pushed outward, facilitating the sliding of the seat 410 to the bottom of the slot 110, allowing the second connecting arm 213 to be inserted into the plug-in hole 402. At this moment, the limiting block 313 on the seat 410 is aligned with the limiting block 313, and under the action of the elastic support, the limiting block 313 is snapped into the limiting hole 403, thereby locking the plug module 400 within the slot 110.

The unlocking part 320 is drivably connected to the limiting part 310, enabling the limiting part 310 to open by driving the unlocking part 320. The unlocking part 320 includes a third plate 321 and an elastic part 322, and the third plate 321 is provided with an abutting block 323. The third plate 321 is slidably connected within the second sliding groove 205, and the elastic part 322 is provided within the second sliding groove 205 and configured to generate the elastic force to the third plate 321 toward the outer side of the second sliding groove 205. The abutting block 323, corresponding to the pushing block 314, is provided on the third plate 321 and configured to extend toward the limiting part 310. Opposite sides of the pushing block 314 and the abutting block 323 are each configured as a slope 324. In response to a case that the third plate 321 is pressed, the elastic force generated by the elastic part 322 is applied to move it along the second sliding groove 205. As a result, the abutting block 323 comes into contact with the pushing block 314, and the limiting part 310 is pushed toward the elastic support. In response to this, the limiting block 313 is disengaged from the limiting hole 403, unlocking the plug module 400 by the limiting part 310, allowing the plug module 400 to be removed from the slot 110 for replacement. After released, the third plate 321 is reset under the force of the elastic part 322, causing the limiting block 313 to extend again toward the slot 110 under the action of the elastic support.

To ensure the smooth and precise sliding of the third plate 321 within the second sliding groove 205, the adapter further includes a sliding limit mechanism. The sliding limit mechanism includes a guide rail 206 and a guiding groove. The guide rail 206 is arranged at the second sliding groove 205 or the third plate 321, and the guiding groove is arranged at the second sliding groove 205 or the third plate 321. An end of the third plate 321 away from the elastic part 322 is configured as a pressing end 325 to be pressed to overcome the elastic force of the elastic part 322 to slide. The third plate 321 is configured to slide along the guiding direction of the second sliding groove 205 and the guide rail 206, ensuring the precision of its movement and preventing any swinging that could affect the reliability of pressing the pressing end 325 of the third plate 321 to drive the third plate 321.

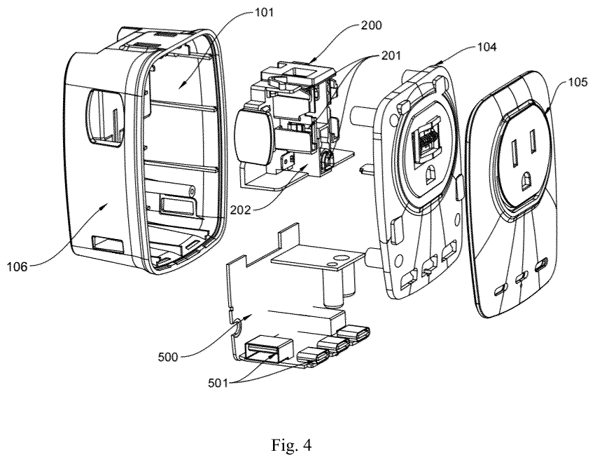

In this embodiment, as shown in FIG. 4, a circuit board 500 is provided within the cavity 101, and is electrically connected to the conductive module 200. And a plurality of electronic ports 501 are provided on the circuit board 500 for current transmission. In this embodiment, the electronic ports 501 may be universal serial bus (USB) ports, Type-C ports, or other common interfaces, allowing for direct connection of transmission cables.

To ensure the aesthetic appeal of the socket surface, the casing assembly 100 includes a bottom casing 106, a middle casing 104, and a top cover 105. The cavity 101 is provided in the bottom casing 106, and the conductive module 200 and the circuit board 500 are securely mounted inside the bottom casing 106. The middle casing 104 is configured to enclose the cavity 101, and a plurality of connection holes are provided on the middle casing 104 for bolted connection to the bottom casing 106. The middle casing 104 is fixedly connected to the top cover 105 using bolts. The connection holes are all provided on the middle casing 104. The top cover 105 is in snap-fit connection with the middle casing 104, thereby covering the connection holes on the middle casing 104 and ensuring a high level of cleanliness on the socket surface, thus avoiding any visual impact from the connection holes.

The embodiments described above are merely preferred embodiments of the present disclosure and are not intended to limit the scope of the present disclosure. Any modifications, variations, and replacements made by those skilled in the art without departing from the spirit of the present disclosure shall fall within the scope of the present disclosure defined by the appended claims.

What is claimed is:

1. An adapter, comprising:
a casing assembly;
a bracket;
a first conductive metal component;
a second conductive metal component; and
a locking mechanism;
wherein a cavity is provided within the casing assembly, and a slot is provided on an outer surface of the casing assembly;
the bracket is detachably provided within the cavity;
the first conductive metal component is provided on the bracket, and provided with an elastic connection portion for plug-in connection;
the second conductive metal component is fixedly provided on the bracket; a first end of the second conductive metal component is electrically connected to the first conductive metal component, and a second end of the second conductive metal component is configured to extend along an outer wall of the casing assembly into the slot; and the second end of the second conductive metal component is configured to extend toward an opening of the slot; and
the locking mechanism is movably provided on the bracket, and comprises a limiting part and an unlocking part; the limiting part is provided with an elastic support, and is configured to extend partially into the slot under the action of an elastic force;
and the unlocking part is structurally matched with the limiting part, and is configured to push the limiting part out to overcome the elastic force to exit the slot.

2. The adapter of claim 1, wherein the bracket is provided with a first plate which is vertically arranged, an assembly frame is provided along the first plate to clamp the first conductive metal component, and the second conductive metal component is fixedly provided on the assembly frame.

3. The adapter of claim 2, wherein the number of the first conductive metal component is two, and two first conductive metal components are respectively corresponding to a live wire and a neutral wire; each of the two first conductive metal components comprises a second plate; the second plate is provide with a plurality of elastic arms; a space between the plurality of elastic arms and the second plate is configured as the elastic connection portion; and each of the two first conductive metal components is provided with a first connecting arm electrically connected to the second conductive metal component.

4. The adapter of claim 3, wherein the number of the second conductive metal component is two, and two second conductive metal components are respectively corresponding to the two first conductive metal components; each of the two second conductive metal components comprises a main body; a first end of the main body is electrically connected to a corresponding one of the two first conductive metal components, and a second end of the main body is configured to extend along the main body into the slot; the second end of the main body is provided with a second connecting arm extending toward the opening of the slot; and a clamping space is defined between the second connecting arm and a side wall of the slot.

5. The adapter of claim 4, wherein the main body is further provided with a reinforcing arm opposite to the second connecting arm, and the clamping space is defined between the reinforcing arm and the second connecting arm.

6. The adapter of claim 2, wherein a sliding groove is provided on the first plate, the limiting part is provided on an upper side or a lower side of the sliding groove, and the limiting part comprises:
a cross beam;
a connecting leg;
a limiting block; and
a pushing block;
wherein the elastic support is provided between the cross beam and the first plate;
the connecting leg is provided on one side of the cross beam, the first plate is provided with a hole, and the connecting leg is configured to pass through the hole and be slidingly connected with the hole along an axis of the connecting leg for limited movement;
the limiting block is provided on the cross beam, and configured to extend into the slot along a side wall of the casing assembly; and
the pushing block is provided on the cross beam, and configured to extend toward the sliding groove; and
the unlocking part comprises:
a second plate;
an elastic part; and
an abutting block;
wherein the second plate is slidably connected within the sliding groove;
the elastic part is provided within the sliding groove, and is configured to provide an elastic force toward an outer side of the sliding groove to the second plate; and
the abutting block is provided on the second plate, and is corresponding to the pushing block; the abutting block is configured to extend toward the limiting part; and
opposite sides between the pushing block and the abutting block are each configured as a slope.

7. The adapter of claim 6, further comprising:
a sliding limit mechanism;
wherein the sliding limit mechanism comprises a guide rail and a guiding groove;
the guide rail is arranged at the sliding groove or the second plate; the guiding groove is arranged at the sliding groove or the second plate; and an end of the second plate away from the elastic part is configured as a pressing end to be pressed to overcome the elastic force of the elastic part to slide.

8. The adapter of claim 1, wherein the casing assembly is provided with a jack corresponding to the elastic connection portion, and the jack is a two-pole jack or a three-pole jack.

9. The adapter of claim 1, wherein a circuit board is provided within the cavity, and is electrically connected to the first conductive metal component; and a plurality of electronic ports are provided on the circuit board for current transmission.

10. The adapter of claim 1, wherein the casing assembly comprises:
a bottom casing;
a middle casing; and
a top cover;
wherein the cavity is provided in the bottom casing;
the middle casing is configured to enclose the cavity, and a plurality of connection holes are provided on the middle casing for bolted connection to the bottom casing; and
the top cover is in snap-fit connection with the middle casing.
